(19) United States
(12) Patent Application Publication
(10) Pub. No.: US 2010/0114837 A1
(43) Pub. Date: May 6, 2010

(54) REMOTE DISASTER DATA RECOVERY SYSTEM AND METHOD

(76) Inventors: Anand Prahlad, East Brunswick, NJ (US); David Ngo, Shrewsbury, NJ (US); Norman R. Lunde, Middletown, NJ (US); Lixin Zhou, Marlboro, NJ (US); Avinash Kumar, Ocean, NJ (US); Andreas May, Marlboro, NJ (US)

Correspondence Address: PERKINS COIE LLP;PATENT-SEA, P.O. BOX 1247, SEATTLE, WA, 98111-1247, US

(21) Appl. No.: 12/686,920

(22) Filed: Jan. 13, 2010

Related U.S. Application Data
(63) Continuation of application No. 10/819,103, filed on Apr. 5, 2004.
(60) Provisional application No. 60/460,226, filed on Apr. 3, 2003.

(51) Int. Cl. G06F 17/00; G06F 12/16; G06F 12/00

(52) U.S. Cl. 707/667; 707/675; 707/E17.005; 711/E12.001; 711/E12.103

(57) ABSTRACT

The present invention provides computer systems, methods, and software products enabling the creation and maintenance of disaster recovery volumes having a reduced impact with regard to network traffic over a communications network. A disaster recovery volume is generally created at a local archival storage unit including therein at least one storage medium constituting the disaster recovery volume. The medium constituting the disaster recovery volume is associated with the primary volume thereby allowing the storage medium constituting the disaster recovery volume to be relocated to a remote archival storage unit at a remote location without compromising the association between the primary volume and the disaster recovery volume. Incremental changes to the primary volume may then be communicated and incorporated in to the disaster recovery relocated to the remote location.

### RELATED APPLICATIONS

This application claims priority to Provisional Application No. 60/460,226, filed Apr. 3, 2003, the entirety of which is hereby incorporated by reference.

This application is related to the following pending applications:
Application Ser. No. 09/610,738, titled MODULAR BACKUP AND RETRIEVAL SYSTEM USED IN CONJUNCTION WITH A STORAGE AREA NETWORK, filed Jul. 6, 2000, attorney docket number 4982/8;
Application Ser. No. 09/609,977, titled MODULAR BACKUP AND RETRIEVAL SYSTEM WITH AN INTEGRATED STORAGE AREA FILING SYSTEM, filed Aug. 5, 2000, attorney docket number 4982/9;
Application Ser. No. 09/354,058, titled HIERARCHICAL BACKUP AND RETRIEVAL SYSTEM, filed Jul. 15, 1999, attorney docket number 4982/5;
Application Ser. No. 09/774,302, titled LOGICAL VIEW WITH GRANULAR ACCESS TO EXCHANGE DATA MANAGED BY A MODULAR DATA AND STORAGE MANAGEMENT SYSTEM, filed Jan. 30, 2001, attorney docket number 4982/11;
Application Ser. No. 09/876,289, titled APPLICATION SPECIFIC ROLLBACK IN A COMPUTER SYSTEM, filed Jun. 6, 2000, attorney docket number 4982/12;
Application Ser. No. 09/038,440, titled PIPELINED HIGH SPEED DATA TRANSFER MECHANISM, filed Mar. 11, 1998, attorney docket number 4982/6;
Application Ser. No. 10/262,556, titled SYSTEM AND METHOD FOR GENERATING AND MANAGING QUICK RECOVERY VOLUMES, filed Sep. 30, 2002 attorney docket number 4982/20; and
Application Ser. No. 60/460,234, titled SYSTEM AND METHOD FOR PERFORMING STORAGE OPERATIONS IN A STORAGE NETWORK, filed Apr. 3, 2003, attorney docket number 4982/35P;

each of which applications is hereby incorporated herein by reference in this application.

### COPYRIGHT NOTICE

A portion of the disclosure of this patent document contains material, which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND OF THE INVENTION

The invention disclosed herein relates generally to systems and methods for providing disaster recovery regarding computer operations. More particularly, the present invention relates to methods and systems for creating and managing remote disaster recovery copies of a volume or volumes of data and/or software.

Disaster recovery generally refers to a plan or strategy for duplicating computer operations, for instance, of a company, wherein copies of a volume or volumes of computer data and/or software of a primary location are established at a remote location thereby providing a redundant measure of protection in the event of a disruption of operations at the primary location. Disaster recovery thereby allows a company to resume operations in the remote location within days as opposed to, in certain instance, a permanent loss in certain aspects of the company's information infrastructure.

Disaster recovery systems appearing in the art provide companies with the ability to create remote backup copies of a volume or volumes of data and/or software. The information necessary to create the backup copies at the remote location is typically communicated to a remote server connected to a client computer over a communications network. Data recovery similarly entails receiving data over the communications network. Systems providing disaster recovery in this fashion, however, have numerous shortcomings with respect to creating backup copies of a volume or volumes having relatively large quantities of data and/or software. For instance, a large data transfer may increase network traffic and thereby consume a large portion of the network's capacity sufficient to slow the company's operations during the transfer. For example, creating a remote backup copy for a server computer having 100 gigabytes of data stored thereon over a company's network with multiple T1 data transfer capability will tie up the company's network for months. This is particularly problematic for companies operating around the clock that may not otherwise limit data transfer to off-peak hours and companies having networks with limited bandwidth. There is therefore a need for remote disaster recovery systems and methods having a reduced impact with regard to network traffic over a company's network.

### BRIEF SUMMARY OF THE INVENTION

The present invention provides methods, systems, and software products that, among other things, enable the creation and maintenance of disaster recovery volumes having a reduced impact with regard to network traffic over a communication network. In one aspect of the present invention, this is accomplished with a disaster recovery computer system including at least one computer having programming associated therewith, the at least one computer communicatively connected to at least one local archival storage unit and at least one remote archival storage unit. The computer programming, when executed, generally provides data transfer and control capability for the creation of a disaster recovery volume of a primary volume at the local storage unit on at least one storage medium, which storage medium constitutes the disaster recovery volume. The programming also associates the storage medium constituting the disaster recovery volume with the primary volume, which allows the storage medium to be relocated to a remote location without compromising the association between the primary volume and the disaster recovery volume. In one embodiment the programming associates the storage medium or media constituting the disaster recovery volume with the primary volume by including therein indicia for identifying the medium as at least a portion of the disaster recovery volume of the primary volume. The indicia may be a tag included in each medium constituting the disaster recovery volume identifying the source of data therein and information regarding the date and time the disaster recovery volume was created.

In one embodiment, the at least one computer is a plurality of computers including at least one client computer and at least one server computer. The client computer having programming associated therewith that provides data transfer and control capability thereto capable of packaging and communicating primary volume data, e.g., the primary data set, to the local storage unit. The programming may be at least one intelligent data agent program module, which provides application specific data packaging capability to the client computer. The server computer may include at least one of a media agent program module and a storage manager program module, the server computer adopted therewith to receive packaged data from the client computer and control the transfer of the packaged data to the local archival storage unit. The server computer may also include at least one of a media agent program module and a storage manager program module, the server computer adopted therewith to receive packaged data and control the transfer of the packaged data to the remote archival storage unit.

The client computer may also include at least one quick recovery agent program module that provides therewith snapshot image packaging capability. In this instance, the quick recovery agent module packages a snapshot image of the primary volume for the creation of the disaster recovery volume of the primary volume at the local archival storage unit. The disaster recovery volume may be created in a variety of formats. In one embodiment, the disaster recovery volume is a snapshot image of the primary volume.

In one embodiment, the client computer includes at least one intelligent data agent program module that provides application specific data packaging capability, the client computer therewith capable of identifying and packaging incremental changes to the primary volume. The server computer may also include at least one of a media agent program module and a storage manager program module, the server computer adopted therewith to receive packaged data representing the incremental changes to the primary volume and control the transfer of the packaged data to the remote archival storage unit.

The server computer may also include at least one media agent program module, the server computer adopted therewith to create a disaster recovery volume of a primary volume from at least one copy selected from the group consisting of: a backup volume of the primary volume, a quick recovery volume of the primary volume, and a snapshot image of the primary volume. The server computer may also include at least one media agent program module, the server computer adopted therewith to create a disaster recovery volume of a primary volume in connection with a quick recovery volume. In this instance, the disaster recovery volume is created from at least one snapshot image of the primary volume.

The server computer may also include at least one media agent program module, the server computer adapted therewith to effect incremental changes to a disaster recovery volume relocated to the remote storage unit. The incremental changes to the disaster recovery volume represent incremental changes to the primary volume. The incremental changes to the disaster recovery volume, in one embodiment, are made in connection with at least one snapshot image of the primary volume taken after the creation of the disaster recovery volume.

In another aspect of the present invention, a computer readable medium is providing which stores therein program code which when executed on a computer, causes the computer to perform a method for creating a disaster recovery volume of a primary volume associated with a first computer. The method, in one embodiment, includes the steps of packaging a primary data set associated with the primary volume, communicating the packaged primary data set associated with the primary volume to a local archival storage unit which includes therein at least one storage medium, copying the packaged primary data set to the at least one storage medium, the at least one storage medium constituting the disaster recovery volume; and associating the at least one storage medium constituting the disaster recovery volume with the primary volume thereby allowing the storage medium constituting the disaster recovery volume to be relocated to a remote archival storage unit at a remote location without compromising the association between the primary volume and the disaster recovery volume. The step of associating the primary volume and the disaster recovery volume may entail including in the medium indicia for identifying the medium as at least a portion of the disaster recovery volume of the primary volume. The indicia may be a tag included in each medium constituting the disaster recovery volume that identifies the source of data therein and information regarding a date and time the disaster recovery volume was created.

The method of creating a disaster recovery volume may also include the step of synchronizing at least one of an application and an operating system associated with the first computer so that essentially all data of the primary data set is copied to the local archival storage unit and so that the primary data set is not modified during the creation of the disaster recovery volume at the local archival storage unit. The synchronizing step may, in certain instances, entail suspending input and/or output to a disk containing at least a portion of the primary data set, and resuming input and/or output to the disk containing at least a portion of the primary data set after the creation of the disaster recovery volume. In one embodiment, the disaster recovery volume is a snapshot image of the primary volume.

The method of creating a disaster recovery volume may also include the steps of identifying incremental changes to the primary volume, packaging data representing incremental changes to the primary volume, and communicating the packaged data over a communications network to the remote storage unit at a remote location. The step of packaging data representing incremental changes to the primary volume may include compressing the data representing incremental changes to the primary volume. The incremental changes to the primary volume may then be incorporated into the disaster recovery volume relocated to the remote location. The incremental changes to the primary volume may be identified in connection with at least one snapshot image of the primary volume. The disaster recovery volume of a primary volume may be made from at least one copy selected from the group consisting of a backup volume of the primary volume, a quick recovery volume of the primary volume, and a snapshot image of the primary volume.

In another aspect of the invention, a method for creating a disaster recovery volume of a primary volume is provide that includes the steps of creating a backup copy of at least a portion of a primary volume on at least one storage medium at a first location, physically transferring the at least one storage medium to a second location remote from the first location, and updating the backup copy at the second location over a communications network to reflect incremental changes to the primary volume subsequent to the creation of the primary backup copy. In one embodiment, the step of creating a backup copy includes the step of associating the storage medium with the primary volume thereby allowing the storage medium to be relocated to the second remote location. In another embodiment, the step of creating a backup copy includes the step of synchronizing at least one of an application and an operating system associated with the primary volume to allow essentially all data of the primary volume to be copied to the storage medium and to prevent the primary volume from being modified.

### BRIEF DESCRIPTION OF THE DRAWINGS

The invention is illustrated in the figures of the accompanying drawings which are meant to be exemplary and not limiting, in which like references are intended to refer to like or corresponding parts, and in which:

FIG. 1 is a block diagram depicting software components and communication paths of program code stored on a computer readable medium providing remote disaster recovery functionality according to at least one embodiment of the invention;

FIG. 2 is a disaster recovery computer system according to an embodiment of the invention; and

FIG. 3 is a flow diagram of a method of creating a disaster recovery volume according to an embodiment of the invention.

### DETAILED DESCRIPTION

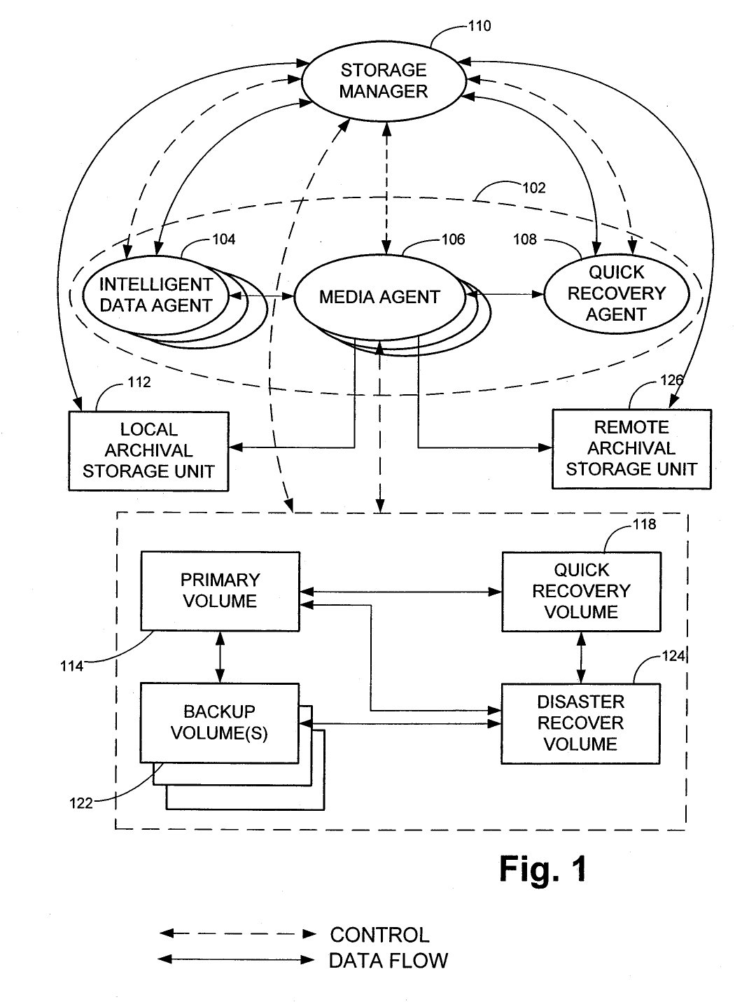

Referring to FIG. 1, software components that may be stored on a computer readable medium enabling the creation and management of disaster recovery volumes of a primary data set associated with a client computer, according to an embodiment of this invention, include at least one agent module 102, such as an intelligent data agent 104, a quick recovery agent 108, a media agent 106, etc., and at least one storage manager module 110. A primary data set generally denotes data, application data, software, executable code, and/or other data and computer programming associated with a client computer that may be used as the source to create the disaster recovery volume 124. A volume generally refers to a physical or logical storage unit, or a portion thereof, which may be stored on one or more data storage devices. A primary volume generally refers to a volume or a portion thereof having the primary data set stored thereon.

An agent module 102 is used herein to generally refer to a program module or application that provides data transfer and control functionality to client computers. A client as used herein refers to a computer with data and/or application programming associated therewith stored on one or more storage media that may be backed up and/or restored in accordance with a disaster recovery plan or restoration. A client therefore includes, but is not limited to, a personal computer, workstation, mainframe computer, a host computer, etc. An intelligent data agent 104 refers to an agent module particular to a specific application, such as Windows 2000 File System, Microsoft Exchange 2000 Database, etc., that provide control and data transfer functionality for data protection and recovery operations of the data and/or programming for the specific applications. A plurality of agents modules 102, such as intelligent data agents 104 and/or quick recovery agents 108, may therefore be provided and/or reside on each client computer, for example, where the client computer includes a plurality of applications and a file system or systems for which a disaster recovery volume may be created and maintained.

A media agent 106 as used herein generally refers to a software module that provides data transfer control for archival storage units 112, such as tape library, a redundant array of independent disk (“RAID”) system, etc., and facilitates local and remote data transfer to and from local and remote archival storage units 112, 126, or between the clients and the local and/or remote archival storage units 126. The media agent 106 may interface with one or more agents modules 102, such as the intelligent data agent or agents 104, quick recovery agent 108, or another media agent 106, to control the data being copied from a client computer to a local or remote archival storage unit 112, 126 and/or to a remote archival storage unit 126 from a local archival storage unit 112. The media agent 106, in on embodiment, controls data transfer to and from a primary volume 114 containing the primary data set to create and maintain at least one of a backup volume 122, a quick recovery volume 118, and a disaster recovery volume 124. Moreover, the media agent 106 may control data transfer to create and maintain a disaster recovery volume from either of the backup volume 122 or quick recovery volume 118.

A storage manager 110 as used herein generally refers to a software module or application that acts as an interface between the plurality of agents, such as the intelligent agents 104, media agents 106, quick recovery agents 108, etc., clients, storage units, etc., and in one embodiment, coordinates and controls data flow between them for data protection and recovery operations. The storage manager may also provide scheduling functionality for the creation of either the backup volumes 114, quick recovery volumes 118, and the disaster recovery volumes 124. The primary volumes 114, quick recovery volume 118, backup volumes 122, and disaster recovery volume 124, may be stored to a variety of storage devices and media, such as tape drives, hard drives, optical drives, etc. In one embodiment, the disaster recovery volume 124 is stored on removable media, such as tape or optical media. The storage devices associated with client computers may be local to the client, such as local drives, or remote to the client, such as remote drives on a storage area network (“SAN”), local area network (“LAN”), or wide area network (“WAN”), etc. The backup volumes 122, the quick recovery volumes 118, and, disaster recovery volume 124 may be snapshot images of the primary volume 114, exact replicas of the primary volume 114, or a compressed version thereof.

A quick recovery agent 108 generally refers to a software module that provides the ability to create snapshot images and quick recovery volumes 118. The quick recovery agent 108 evokes a snapshot mechanism or interfaces with a snapshot manager that provide for the creation of a snapshot image of the primary volume 114, which may be used to create a quick recovery volume 118, a backup volume 122, or a disaster recovery volume of the primary data set. In one embodiment, the quick recovery agent 108 interfaces with snapshot image programming, such as XP/.NET, TimeFinder, etc., that creates snapshot images or shadowed copies of the primary data set. In one embodiment, the quick recovery agent 108 interfaces with a snapshot manager agent module, which may be an intelligent agent, that generally controls data transfer from the primary volume 114 for the creation of a snapshot image, and a snapshot requestor and writer agent modules, which may also be an intelligent agents, which package the primary data set for the creation of the snapshot image by the snapshot image programming. Aspects of the quick recovery volumes and agents are discussed in greater detail in U.S. application Ser. No. 10/262,556, entitled SYSTEM AND METHOD FOR GENERATING AND MANAGING QUICK RECOVERY VOLUMES, which is hereby incorporated herein by reference.

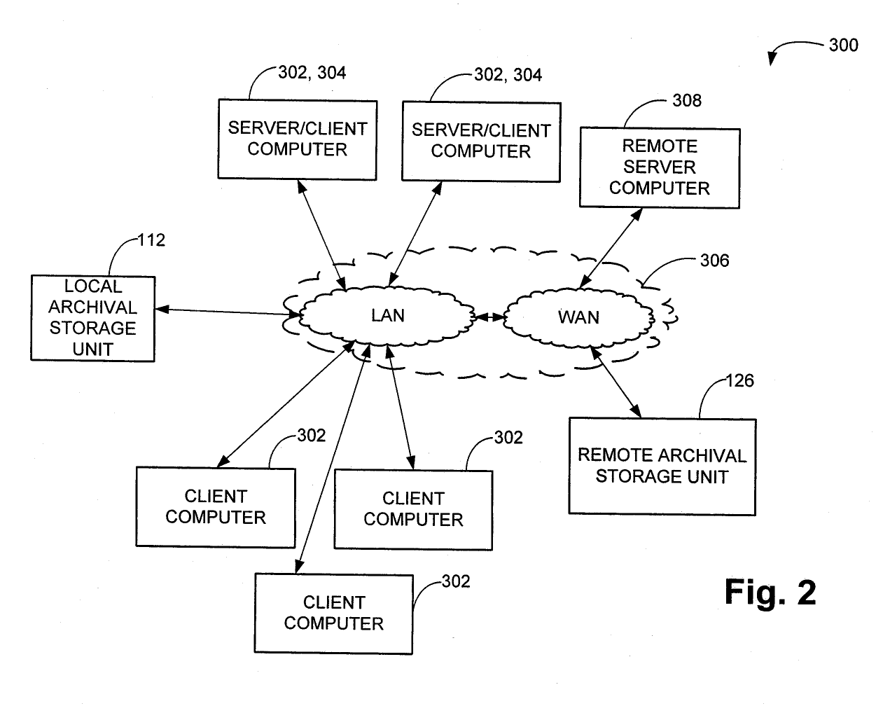

Referring to FIG. 2 a disaster recovery computer system, according to one embodiment of the invention, includes at least one server computer 304, 308 communicatively connected to at least one client computer 302, such as a personal computer, a workstation, a server computer, a host computer, a mainframe computer, etc., and at least one archival storage unit over a communications network 306. In one embodiment, the system includes at least one local archival storage unit 112 and at least one remote archival storage unit 126. The communications network 306 is any suitable communications link, such as a LAN, WAN, the Internet, or any combinations thereof. In one embodiment, the communications network 306 includes at least one LAN that interconnects client computers 302, server computers 304 and local archival storage units 112 at a primary location, and a WAN that connects the computers at the primary location with the equipment at a remote location, e.g., remote server 308 and/or the remote archival storage unit 126. A remote location is herein used to denote a geographic location other than the location or locations of the primary volume 114. The distance between the remote and primary location may vary depending on the desired level of redundancy. For instance, disaster recovery enabled to provide redundancy in the event of a local power failure may be achieved by separating the primary and remote sites such that the locations are not in the same building. A greater level of redundancy may be achieved by separating the location such that they do not share a common power supply source, such as in a different town, city, state, country, etc. For example, a local site may be located in New York City and a remote site in Dallas Tex.

In one embodiment of the present invention, the client computers 302 contain programming, such as intelligent data agents 104, media agents 106, quick recovery agents 108, and/or a storage manager 110, which provides the functionality for creating and maintaining local and/or remote copies, and/or snapshot images of a primary data set. The copies may be at least one of backup volumes 122, quick recovery volumes 118, and a disaster recovery volume or volumes 124. The backup volumes may further be primary copies, secondary copies, etc. The copies may be stored or copied either locally at the client computer, such as on a local hard drive, tape drive, optical drive, etc., or remote from the client on at least one local archival storage unit 112, such as a tape library, a stand alone drive, a RAID cabinet, etc. In one embodiment, at least one of the copies, such as the disaster recovery volumes 124, is stored and maintained at a remote site.

The client computer 302, according to one embodiment, includes at least one intelligent data agent 104, which provides the data transfer and control functionality for the client computer 302. The intelligent data agent 104 provides the data transfer and control functionality by identifying and packaging the application specific data of the primary volume 114 to be backed up. Packaging generally denotes parsing data and logically addressing the data that is to be used in order to facilitate the creation of the disaster recovery volume 124. For example, where a snapshot of the Microsoft Exchange application is to be created, the Exchange specific intelligent agent will parse the relevant data from the primary volume 114, e.g., the disk or disks containing the application data, and logically address the parsed data to facilitate rebuilding the parsed data for the disaster recovery volume 124. In one embodiment, the intelligent data agent 104, which can be aided by the storage manager 110, packages the primary data set into a backup format or other format and copies the data to a backup copy or copies. For example, in some embodiments an intelligent data agent 104 packages a the data according to Galaxy's backup format or another backup format or secondary storage format as further described in U.S. Pat. Nos. 5,559,991, 5,642,496, and 6,418,478 each of which is hereby incorporated herein by reference in their entirety. In some embodiments, the intelligent data agent 104 packages additional information with the primary data such as information regarding how applications recognize the data, where data is physically located on the backup copy, where snapshot data is logically located on the backup copy, application-specific preferences associated with the data, and other information. The additional information can be included, for example, in header information of the data, in the payload of the data, or in combinations thereof. In some embodiments, the intelligent data agent 104 does not package the data into a backup format, and instead copies the data in its original format, for example, in the case of creating a quick recovery volume or a disaster recovery volume.

In one embodiment, the client computer includes at least one quick recovery agent 108, which creates or interfaces with a snapshot image program to create a snapshot image of the primary volume for use in the creation of the disaster recovery volume 124. The primary data set may thus be packaged by the quick recovery agent 108 or by snapshot requestor and writer agents, which interface with the quick recovery agent 108.

As noted above, the client computer 302 may also be a server computer 304, and may therefore also include programming, such as a media agent 106 and/or a storage manager 110, which controls data transfer to and from the client computers 302 and the archival storage units 112, 126. In one embodiment, at least one server 304 at the primary location and at least one server at the remote site 308 include programming, such as at least one media agent 106 and a storage manager 110 that control data transfer between a client computer 302 at the primary site and, a local and/or remote archival storage unit 126.

Disaster recovery having a reduced impact on network traffic, according to the present invention, generally entails initially creating a disaster recovery volume 124 locally at a primary location and later transferring the disaster recovery volume 124 to a remote location to provide the requisite redundancy in accordance with the disaster recovery plan. For example, a disaster recovery volume of a server A in New York City may initially be created in New York City and later removed from server A or a archival storage unit associated therewith and installed in an archival storage unit B in a remote site in Dallas. Redundancy with respect to changes in the primary volume 114, e.g., the primary data set, subsequent to the creation of the disaster recovery volume 124 may further be provided by incrementally changing or effecting changes to the disaster recovery volume 124 at the remote location to reflect the changes to the primary volume 114 at the primary location. This aspect of the invention effectively alleviates network traffic that would otherwise be required to create a disaster recovery volume 124 at the remote site over the communication network. It is understood that this aspect of the present invention may be accomplished in a variety of ways.

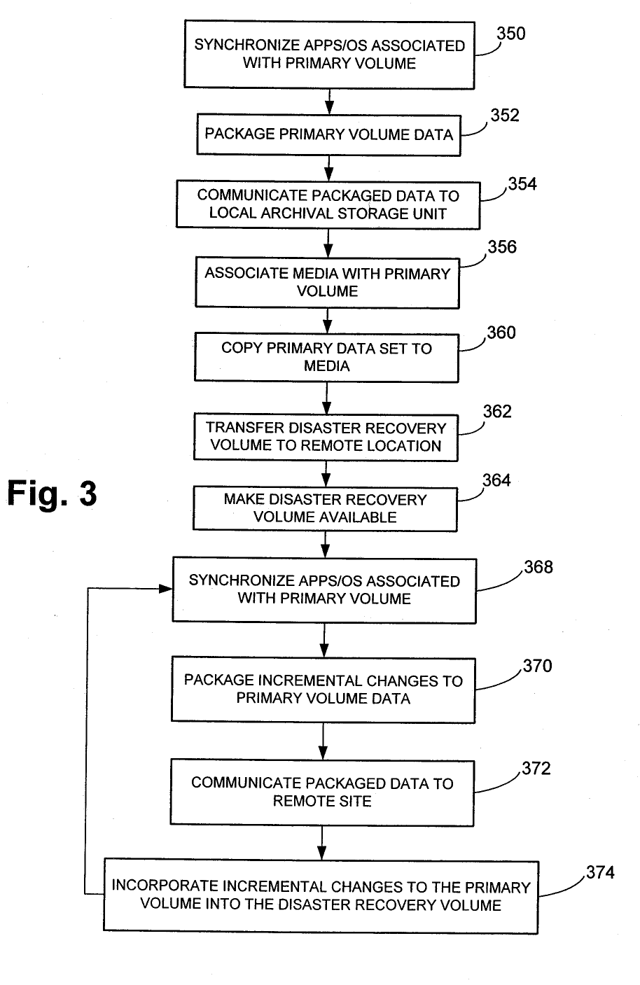

Referring to FIG. 3, a method of creating a disaster recovery volume, according to one embodiment, begins by synchronizing the applications and/or operating system associated with a client computer 302 to ensure that essentially all data of the primary volume 114 to be backed up in accordance with a disaster recovery plan is copied to the local archival storage unit 112 where the disaster recovery volume 124 will be stored at least initially during the creation of the disaster recovery volume 124 and to ensure, among other things, that the primary data set is not modified during the creation of the disaster recovery volume 124, step 350. This may be accomplished, for instance, by suspending input and/or output to the disk containing the primary data set, which will ensure that the file system and metadata remain unchanged during the copy operation. Alternatively or in addition, the disk or disks comprising the primary volume 114 may be dismounted during the copy operation and remounted when the copy is complete. In another alternative embodiment, input and/or output to the disk containing the primary data set is not suspended and/or unmounted during the copy operation.

The primary volume 114, e.g., the primary data set, may then be packaged, e.g., by the intelligent data agent 104 and/or the quick recovery agent 108, step 352, and communicated, step 354, to the local archival storage unit 112 for the creation of the disaster recovery volume 124. As noted above, the disaster recovery volume 124 may be a snapshot image of the primary volume 114, an exact replica of the primary volume 114, or a compressed version thereof. Thus, the intelligent data agent 104 and/or the quick recovery agent 108 may additionally compress the primary data set in the packaging process. The packaged data may be communicated to either a media agent 106 and/or a storage manager 110, at a local and/or a server computer 302, 308, which generally control the data transfer between the client devices 302 and the archival storage units 112, 126.

In one embodiment, at least one storage medium that will constitute the disaster recovery volume 124 at the local archival storage unit 112 is associated with the primary volume 114, step 356. Associating the media generally denotes including therein indicia or other means for identifying the media as being or belonging to a set of media that constitute the disaster recovery volume 124 of a primary data set such that the disaster recover volume 124 may be removed from the primary location and relocated to a remote site without compromising the association between the primary volume 114 and the disaster recovery volume 124, which may result in corrupting the data thereon. This may be accomplished, for instance, by including appropriate identifying information in the header of the storage media or including a tag in each medium, which identifies the source of the data for the disaster recover volume 124, such as the particular client computer 302, the primary volume 114, etc. The header or tag may also provide information with regard to when the disaster recovery volume was created, such as the date and time of creation. The association provides, for instance, means for ensuring that, after relocating the disaster recovery volume 124 to a remote site, subsequent incremental updates to the primary volume A, for example, may be incorporated into the disaster recovery volume of the primary volume A and not in disaster recovery volume for any other primary volume, which may result in corrupting the data therein. The association further provides means for ensuring that multiple incremental updates in the primary volume are properly applied to the disaster recovery volume in proper order further preventing data corruption.

The packaged data may then be copied to the disaster recovery storage medium or media, step 360. It is also understood that the copy procedure may be accomplished in a variety of ways and also using a variety of methods. For instance, the copy operation may be a disk-to-disk data-block-level replication of the primary data set to provide an exact replica of the primary volume 114, the creation of an image or the primary volume 114, or may incorporate data compression to produce a compressed versions thereof. Additionally, the disaster recovery volume 124 may be created from previous backup volumes 122, such as primary and secondary copies, a quick recovery volume 118, or one or more snapshot images of the primary volume 114. Copying from or in connection with a quick recovery volume 118 and/or snapshot images of the primary volume 114 entails creating the copy of the primary data set from a snapshot image or images of the primary data set as opposed to the actual primary volume 114 thereby minimizing the suspension of the input or output to primary volume 114. Once the disaster recovery volume 124 is created, input or output to the primary volume disk or disks may then resume.

The disaster recovery volume 124 may then physically be removed from the local archival storage unit 112 at its initial storage location at the primary site, such as by removing the media from a tape or optical jukebox, and physically transferred or relocating the disaster recovery volume 124 to the remote site, step 362. The transfer process entails transporting the media constituting the disaster recovery volume 124 to the remote site, which may be located in a different city, state, country, etc., where the disaster recovery volume 124 may be placed into the remote archival storage unit 126, e.g., the tape or optical jukebox. The disaster recovery volume 124 may then be made available as a remote disaster recovery volume 124 for data protection and/or recovery of the primary data volume 114 based on the media association with the primary volume, step 364.

Once the disaster recovery volume 124 is made available, incremental changes to the primary data set or to the primary volume may be tracked and communicated to the remote site over the communications network 306 so that the incremental changes may be incorporated into the disaster recovery volume 124 at the remote location, step 374. The incremental changes may be made periodically, such as daily, weekly, etc. It is understood that the incremental changes may be incorporated into the disaster recovery volume 124 in a variety of ways. In one embodiment, incrementally changes to the primary volume are incorporated into the disaster recovery volume 124 by first synchronizing the applications and/or operating system of a client computer associated with the primary volume 114, step 368. Incremental changes to blocks of data of the primary volume 112 after the creation of the disaster recovery volume 124 or any previous incremental update to the disaster recovery volume 124 of the primary volume 114 may then be packaged, such as by the intelligent data agent 104 or quick recovery agent 108, step 370, and communicated over a communications network 306 to the remote site, e.g., the remote archival storage unit 126, step 372, where the packaged data will be incorporated into the particular disaster recovery volume 124 for the primary volume 124, step 374. The packaged data may be packaged in a storage operation format, a backup format, a compressed format, or the original format.

In some embodiments, the intelligent data agent 104 and/or the quick recovery agent 108 packages additional information with the changed blocks such as information regarding how applications recognize the changed block data, where changed block data is physically located on the primary volume 114, where changed block data is logically located on the primary volume 114, application-specific preferences associated with the changed block data, and other information. The additional information can be included in header information of the changed block data being copied to the disaster recovery volume 124, in the payload of the changed block data being copied to the disaster recovery volume 124, or in combinations thereof. The incremental changes may also be made in conjunction with snapshot images of the primary volume taken after the creation of the disaster recovery volume further reducing the suspension of access to the primary volume 114. The data recovery volume 124 of the primary volume 114 is therefore, in accordance with the present invention, available as a disaster recovery volume 124, which is available for resumed operations in the event of a disruption of operations at the primary location and/or for data recovery, and which was created with limited or reduced impact with regard to network traffic on the companies network.

Some of the embodiments of the present invention leverage existing features of the CommVault Galaxy backup system. It will be recognized by those skilled in the art, however, that the embodiments of the present invention may be applied independently of the Galaxy system. While the invention has been described and illustrated in connection with preferred embodiments, many variations and modifications as will be evident to those skilled in this art may be made without departing from the spirit and scope of the invention, and the invention is thus not to be limited to the precise details of methodology or construction set forth above as such variations and modification are intended to be included within the scope of the invention.

1. A disaster recovery computer system comprising:
a primary volume located at a first location, comprising a primary data set to be archived for disaster recovery;
at least one computer having programming associated therewith, the at least one computer communicatively connected to the primary volume;
at least one local archival storage unit communicatively connected to the computer and located at the first location, wherein
(a) the computer programming when executed provides data transfer and control capability to create at the local archival storage unit a disaster recovery volume of the primary volume on at least one storage medium, and
(b) the computer programming stores in the at least one storage medium an identification of the data source to identify that the disaster recovery volume on the at least one storage medium corresponds with the primary volume; and
at least one remote archival storage unit at a second location for receiving the disaster recovery volume when it is physically relocated away from the first location of the primary volume to make a remote disaster recovery volume available for data protection or recovery of the primary volume, wherein the identification of the data source stored in the at least one storage medium at the local archival storage unit is maintained with the disaster recovery volume upon relocation to the at least one remote archival storage unit to enable disaster recovery of the primary volume at the at least one remote archival storage unit.

2. The system of claim 1 wherein the at least one computer comprises at least one client computer and at least one server computer, the client computer having programming associated therewith providing data transfer and control capability thereto capable of packaging and communicating primary volume data to the local archival storage unit.

3. The system of claim 2, the client computer comprising at least one intelligent data agent program module therewith providing data packaging capability to the client computer specific to user application data of the primary volume to be archived.

4. The system of claim 3, the server computer comprising at least one of a media agent program module and a storage manager program module, the server computer adapted therewith to receive packaged data from the client computer and control the transfer of the packaged data to the local archival storage unit.

5. The system of claim 3, the server computer comprising at least one of a media agent program module and a storage manager program module, the server computer adapted therewith to receive packaged data from the client computer and control the transfer of the packaged data to the remote archival storage unit.

6. The system of claim 2, the client computer comprising at least one quick recovery agent program module providing therewith snapshot image packaging capability, the quick recovery agent module capable of packaging a snapshot image of the primary volume for the creation of the disaster recovery volume of the primary volume at the local archival storage unit.

7. The system of claim 6, wherein the disaster recovery volume comprises a snapshot image of the primary volume.

8. The system of claim 2, the client computer comprising at least one intelligent data agent program module that provides application specific data packaging capability, the client computer therewith capable of identifying and packaging incremental changes to the primary volume.

9. The system of claim 8, the server computer comprising at least one of a media agent program module and a storage manager program module, the server computer adapted therewith to receive packaged data representing the incremental changes to the primary volume and control the transfer of the packaged data to the remote archival storage unit.

10. The system of claim 2, the server computer comprising at least one media agent program module, the server computer adapted therewith to create a disaster recovery volume of a primary volume from at least one copy selected from the group consisting of: a backup volume of the primary volume, a quick recovery volume of the primary volume, and a snapshot image of the primary volume.

11. The system of claim 2, the server computer comprising at least one media agent program module, the server computer adapted therewith to create a disaster recovery volume of a primary volume in connection with a quick recovery volume, the disaster recovery volume created from at least one snapshot image of the primary volume.

12. The system of claim 2, the server computer comprising at least one media agent program module, the server computer adapted therewith to affect incremental changes to a disaster recovery volume relocated to the remote storage unit, the incremental changes representing incremental changes to the primary volume, the incremental changes made in connection with at least one snapshot image of the primary volume taken after the creation of the disaster recovery volume.

13. The system of claim 2, wherein a tag is included in each medium of the at least one storage medium storing a disaster recovery volume, which identifies the source of data therein and information regarding a date and time the disaster recovery volume was created.

14. A disaster recovery computer system comprising at least one client computer and at least one server computer each communicatively interconnected to at least one local archival storage unit and at least one remote archival storage unit, the client and server computers having programming associated therewith that when executed provides data transfer and control capability to create a disaster recovery volume of a primary volume on at least one storage medium, which at least one storage medium constitutes the disaster recovery volume, at the local archival storage unit, wherein the computer programming identifies the primary volume as corresponding to the disaster recovery volume by including a tag in the at least one storage medium that maintains an association between the at least one storage medium and the primary volume to provide for disaster recovery of the primary volume after the at least one storage medium is relocated to a remote location, the computer programming further identifies and packages incremental changes to the primary volume and communicates the incremental changes over a communications network to a particular disaster recovery volume relocated to the remote archival storage unit at a location remote from the local archival storage unit.

15. A computer readable medium storing program code which when executed on a computer, causes the computer to perform a method for creating a disaster recovery volume of a primary volume associated with a first computer, the method comprising:
packaging a primary data set associated with the primary volume;
communicating the packaged primary data set associated with the primary volume to a local archival storage unit including therein at least one storage medium;
copying the packaged primary data set to the at least one storage medium, the at least one storage medium constituting the disaster recovery volume; and
associating the at least one storage medium constituting the disaster recovery volume with the primary volume by storing in the at least one storage medium an identification of the data source that is maintained after the disaster recovery volume is relocated to a remote archival storage unit at a remote location to provide disaster recovery of the primary volume at a remote disaster recovery volume.

16. The computer readable medium of claim 15, wherein the method of creating a disaster recovery volume further comprises synchronizing at least one of an application and an operating system associated with the first computer so that data of the primary data set is copied to the local archival storage unit and so that the primary data set is not modified during the creation of the disaster recovery volume at the local archival storage unit.

17. The computer readable medium of claim 16, wherein the step of synchronizing at least one of an application and an operating system associated with the first computer comprises suspending at least one of input and output to a disk containing at least a portion of the primary data set and resuming at least one of input and output to the disk containing at least a portion of the primary data set after the creation of the disaster recovery volume.

18. The computer readable medium of claim 15, wherein the disaster recovery volume comprises a snapshot image of the primary volume.

19. The computer readable medium of claim 15, wherein the step of associating the primary volume with the at least one storage medium storing the disaster recovery volume comprises including therein indicia for identifying the at least one storage medium as at least a portion of the disaster recovery volume of the primary volume.

20. The computer readable medium of claim 19, wherein the indicia comprises a tag included in each medium of the at least one storage medium storing the disaster recovery volume, which identifies the source of data therein and a date and time that the disaster recovery volume was created.

21.-43. (canceled)
